(19) United States
(12) Patent Application Publication
(10) Pub. No.: US 2022/0043823 A1
(43) Pub. Date: Feb. 10, 2022

(54) VALUE-ALIGNED RECOMMENDATIONS

(71) Applicant: Twitter, Inc., San Francisco, CA (US)

(72) Inventors: Luca Belli, San Francisco, CA (US); Smitha Milli, Berkeley, CA (US)

(21) Appl. No.: 16/989,870

(22) Filed: Aug. 10, 2020

(51) Int. Cl. G06F 16/2457; G06F 16/9538; G06F 16/9535; G06N 20/00; G06N 5/04

(52) U.S. Cl. CPC G06F 16/24578; G06F 16/9538; G06N 5/04; G06N 20/00; G06F 16/9535

(57) ABSTRACT

Methods, systems, and apparatus, including computer programs encoded on computer storage media, for ranking items for presentation to a user based on a model that estimates value to the user. One method includes providing value-based training data, the training data including user features, features of corresponding content items presented to users, and respective values of a value variable determined from user behaviors with respect to content items presented to the users; training a scoring model on the training data to generate value-based scores from user content item features; ranking a plurality of candidate content items selected for a first user by a ranking engine, wherein the ranking engine receives respective value-based scores generated by the trained scoring model for the candidate content items and the first user; and providing two or more of the candidate content items for presentation to the first user in an order determined by the ranking.

### BACKGROUND

This specification relates to recommender systems or engines, in particular to systems that make recommendations of items of electronic content (“content items”) for a particular user.

Most recommender engines today are based on predicting user engagement, e.g., predicting whether or not a user will click on a content item, reply to it, or forward it to others. Generally, models are built based on past user engagements with other items of content, and past engagements of other users with items of content. Recommender engines can be based on wide linear models, e.g., models based on cross-products of features, on deep neural network models, or a combination of such and other types of models, which are generally trained using machine learning methods.

### SUMMARY

This specification describes technologies for making predictive estimates of how much value a user will see in a content item. These technologies generally involve the use of a latent variable model that implements a latent variable representing the value a user finds in a content item.

### BRIEF DESCRIPTION OF THE DRAWINGS

FIG. 1 illustrates an example directed acyclical graph representing a Bayesian network for a latent variable model.

FIGS. 2A, 2B, and 2C illustrate a method for calculating the joint distribution of a latent value variable and observed user behaviors from a Bayesian network that encodes user interactions with a system.

FIG. 3 illustrates an example flow of data and processing for training a scoring model to generate scores corresponding to value.

FIG. 4 illustrates an example flow of data and processing in which a scoring model is used in connection with a ranking engine.

FIG. 5 illustrates an example online social messaging platform and example user devices configured to interact with the platform over one or more data communication networks.

Like reference numbers and designations in the various drawings indicate like elements.

### DETAILED DESCRIPTION

Most recommender engines today are based on predicting user engagement.

However, the inventors have recognized that there is potentially a large gap between engagement signals and a desirable notion of value to the user that is worth optimizing for. This specification describes how an implementation of a latent variable model can be used to operationalize a target construct of value and directly optimize for it. Value is treated as an unobserved construct that is specified through a model that links the construct, operationalized as a latent variable, to observed data.

The construct for value is operationalized through a latent variable model (“LVM”) in which the construct for value is represented by V, a binary, unobserved, latent variable, for which the observed user behaviors Behaviors provide evidence. By learning the joint distribution of the latent variable V and the user behaviors, i.e., the user actions, in training a recommender system model one can directly optimize for [symbol] (V|Behaviors), i.e., the conditional probability of V given the observed user behaviors

Advantageously, the LVM is represented as a Bayesian network, i.e., a directed acyclic graph (DAG) that graphically encodes a factorization of the joint distribution of the variables in the network. In particular, the DAG encodes all conditional independences among the nodes through the d-separation rule. The observed behaviors have complex dependencies among each other, e.g., one may need to click on an item before replying to it. The DAG can model both the dependencies among the observed behaviors as well as the dependence of the unobserved variable V on the observed behaviors.

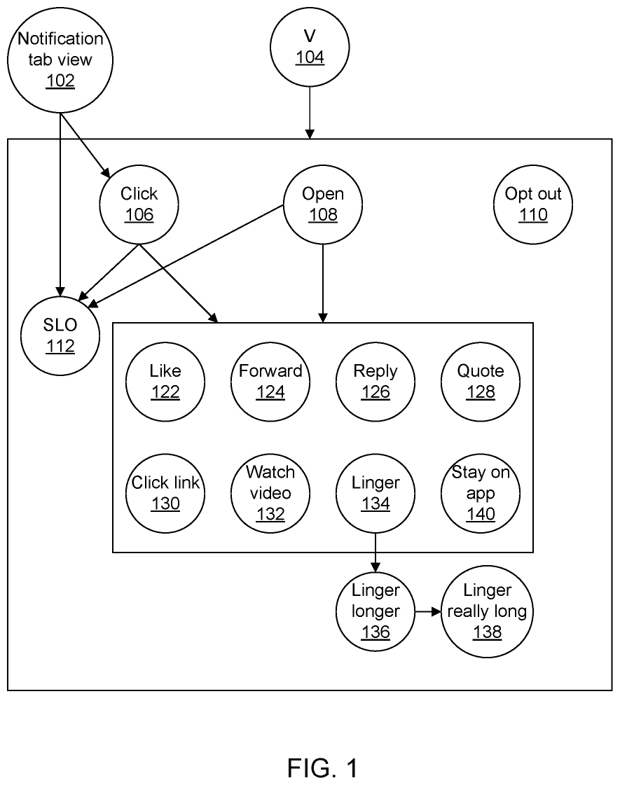

FIG. 1 illustrates an example directed acyclical graph representing a Bayesian network for a latent variable model.

The Bayesian network illustrated in FIG. 1 succinctly encodes the dependencies between different types of interactions users can have with content, in this example, the content is notifications in a micro-blogging or social network application. In the figure, an arrow from a node X to a box means that the node X is a parent in the graph of all the nodes in the box.

In the interactions underlying this example, an application server sends notifications to the user's home screen on the user's mobile phone, for example, and to a notifications tab within a client app. The user can start their interaction either by seeing the notification in their notification tab, notification tab view 102, and then clicking on it, click 106, or by seeing it as a notification on their client app home screen and opening it from there directly, open 108.

After clicking or opening the notification, the user can perform many more interactions to engage with the message, or other content, that is the subject of the notification. For example, the user can like 122, forward 124, reply to, 126, or quote 128 the message; and if the message has a link, user can click on it, click link 130; and if the message has a video, the user can watch it, watch video 132. In addition, other behavior based signals can be represented: whether the amount of time the user lingered on the message exceeds one or more predetermined thresholds, linger 134, linger longer 136, and linger really long 138, with respective increasing threshold times of, for example, 5, 10, and 15 seconds, respectively; and whether the time the user remained active in the app after clicking or opening the notification, stay on app 140, exceeds a threshold, e.g., one minute, two minutes, or five minutes.

When the user is in the notification tab, the user can provide explicit feedback on a particular notification by selecting a see-less-often action, SLO 112. Notably, unlike other types of user engagement, a user does not need to click or open a notification before clicking SLO. However, users often do so. Thus, in addition to notification tab view, click and open are also modeled as parents of SLO.

Finally, at any time, the user can opt-out of notifications to their phone home screen, Opt Out 110. When the user decides to opt-out, it is attributed to any notification shown within a respective threshold time, e.g., one hour, four hours, or one day, of the user's choosing to opt out. The threshold time is advantageously selected to cover a small number of notifications in general, e.g., one to three, so that the number of notifications to which the opt out is attributed will generally be small.

The latent variable V is modeled in the graph as a parent of all behaviors except notification tab view, because, in this example, users may check their notifications tab for many kinds of notifications, so it is difficult to attribute a viewing of the notification tab to a particular notification, and so it is modeled as an exogenous, random event.

In the implementation described below, one particular observed behavior is represented by an anchor variable A. All other observed behaviors are represented in a binary random vector B=(B₁, . . . , Bₙ). The variable A is referred to as an anchor variable, because it provides the link to identifying [symbol] (V|A, B). In other words, it anchors the other observed variables B to V. Because the anchor A is chosen to be a strong type of explicit feedback, it is expected to be the last type of behavior the user engages in on a content item, and thus A is modeled as having no children. Examples of strong negative feedback can include, for example, clicking a button that says “show less often” (“SLO”) with reference some content, reporting content, e.g., reporting it as spam, misinformation, or not safe for work, or blocking another user. Examples of positive feedback can include explicitly liking or up-voting an item. Examples of strong positive feedback can include, for example, a positive response to question asking whether to present more content like a particular content item. For negative feedback, the value used for the conditional probability [symbol] (V=1|A=1)=∈ for ∈≈0, while for positive feedback the value used is [symbol] (V=1|A=1)=1−∈. While approximately equal to zero in both cases, the value of E does not have to be the same in both cases.

The probability of value V given all behaviors B, [symbol] (V|B), can be learned through the use of an anchor variable A for which [symbol] (V=1|A=1) is known.

The following notation will be used in this specification: Pa(X) denotes the parents of a node X in the graph; and Pa_v (X) denotes the parents of X excluding the node V, if V is a parent.

The techniques that are described below determine the conditional probability [symbol] (V|A, B) so that it can later be used as a target for model optimization.

The distribution of observable nodes [symbol] (A, B) is estimated by the distribution of observed data for A and B.

The distribution [symbol] (V) over the latent variable for V is a prior distribution that can specified by hand. Because the prior [symbol] (V) only has a scaling effect in the calculations, it can be set to be uniform, i.e., [symbol] (V=1)=0.5.

The distribution [symbol] (Pa_v (A) V) is also determined. When V is independent of the other parents, i.e., of nodes Pa_v (A), then [symbol] (Pa_v (A)|V)= [symbol] (Pa_v (A)) and is given by the distribution of observed variables P (A, B). When the other parents are not independent of V, [symbol] (Pa_v (A)|A) is estimated heuristically, e.g., by using two sources of historical data that vary in their distribution of V.

An example method of estimating the probability heuristically uses a dataset R of historical recommendations that were sent to users at random and a dataset of C of historical recommendations that were chosen, e.g., by an algorithm or a machine learning model. The randomized and chosen datasets will have different distributions of valuable content, denoted [symbol] _{R} (V) and [symbol] _{C}(V), as well as different distributions of observed behavior, [symbol] _{R} (A, B) and [symbol] _{C} (A, B). However, [symbol] (A, B|V), i.e., the probability of the observed behavior given V, will be the same between the two datasets. If the DAG representing the LVM has V as a root node and can be interpreted as a causal Bayesian net, then difference between the datasets corresponds to an intervention on V, and the following two equations hold:

[symbol]

_{R}(Pa_v(A))= [symbol] (Pa_v(A)|V=1) [symbol] _{R}(V=1)+ [symbol] (Pa_v(A)|V=0) [symbol] _{R}(V=0) (1)

[symbol]

_{C}(Pa_v(A))= [symbol] (Pa_v(A)|V=1) [symbol] _{C}(V=1)+ [symbol] (Pa_v(A)|V=0) [symbol] _{C}(V=0) (2)

After specifying [symbol] _{R}(V) and [symbol] _{C}(V) and having the empirically estimated distributions [symbol] _{R}(A, B) and [symbol] _{C}(A, B), equations 1 and 2 are solved to estimate [symbol] (Pa_v (A) V=1). The specification of [symbol] _{R}(V) and [symbol] _{C}(V) depends on the application, but generally the randomized dataset has a lower value than the choice-based one: [symbol] _{R}(V)< [symbol] _{C}(V). In other words, in general, the probability of opening an item, e.g., a notification, when given random recommendations is lower than when given one that was chosen, e.g., by a model.

It should be noted that while this heuristic approach is appropriate for getting a rough estimate, in practice not all differences between the randomized and algorithmic dataset are necessarily explained by an intervention on V, depending on how the recommendations leading to the algorithmic data were generated. For example, if the recommendation algorithm had historically been optimized for user clicks, then users in the algorithmic dataset may have clicked on items more, but for reasons other than increased value.

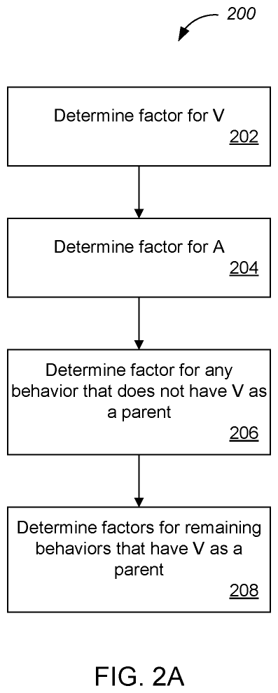

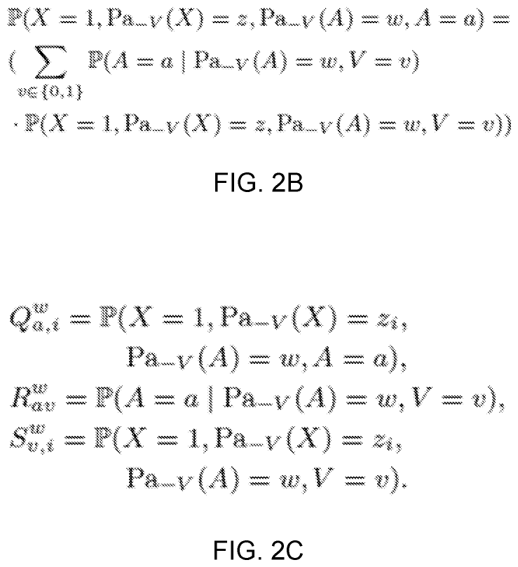

FIG. 2A illustrates a method for calculating the joint distribution [symbol] (V, A, B) given the distributions [symbol] (V), [symbol] (A, B), [symbol] (V=1|A=1) and [symbol] (Pa_v (A)|V). The structure of the Bayesian network is used to efficiently identify the joint distribution [symbol] (V, A, B) by fitting each factor [symbol] (X|Pa(X)) of the joint distribution for every variable X to the data of user behaviors.

The method 200 determines (202) the factor for V of the joint distribution as the prior [symbol] (V).

The method determines (204) the factor for A, i.e., P (A1|Pa(A)), of the joint distribution from the distributions [symbol] (V), [symbol] (V=1|A=1), and P (Pa_v (A)|V)) by solving the following set of linear equations for the four unknown probabilities p_{w,0,0}, p_{w,0,1}, p_{w,1,0}, and p_{w,1,1}.

[symbol]

(Pa_v(A)=w,A=0)=p_{w,0,0}+p_{w,0,1} (3)

[symbol]

(Pa_v(A)=w,A=1)=p_{w,1,0}+p_{w,1,1} (4)

[symbol]

(Pa_v(A)=w,V=0)=p_{w,0,0}+p_{w,1,0} (5)

[symbol]

(Pa_v(A)=w,V=1)=p_{w,0,1}+P_{w,1,1} (6)

The left-hand sides of equations 3 and 4 are given by [symbol] (A, B), and the left-hand sides of equations 5 and 6 are given by [symbol] (V) and P (Pa_v (A)|V), respectively.

In the present context, one-sided conditional independence is assumed. That is, it is assumed that when a user has opted to give feedback (A=1), the level of information the feedback contains about V does not depend on the other parents of A. The assumption rests on the selection of A, because A is a strong type of feedback that users are expected to provide only when they are confident of their assessment. Under this assumption, the probability p_{w,1,1} is determined by the already given distributions:

$$\begin{matrix}{p}_{w , 1 , 1} = ℙ ( A = 1 ) \cdot ℙ ( Pa\_v ( A ) = a \vert A = 1 ) \cdot ℙ ( V = 1 \vert A = 1 , Pa\_v ( A ) ) \\ = ℙ ( A = 1 ) \cdot ℙ ( Pa\_v ( A ) = a \vert A = 1 ) \cdot ℙ ( V = 1 \vert A = 1 )\end{matrix}$$

Since p_{w,1,1} is determined by the given distributions, so are p_{w,0,0}, p_{w,1,0}, and p_{w,0,1}, which can be solved for through equations 3-6. In the above equation, a is the value of the anchor variable, either 0 or 1.

The method determines (206) the factor for any behavior that does not have V as a parent as the distribution of observable behaviors [symbol] (A, B).

Finally, the method determines (208) the factors for the remaining behaviors that do have V as a parent using a matrix adjustment method as follows.

The calculation is based on the equation shown in FIG. 2B.

This equation written in matrix form is shown in FIG. 2C. There, z₁, . . . , zₘ are all the realizations of Pa_v (X), w is a binary vector of the behaviors nodes that are parents of A excluding V, and the matrices Q^{w} ∈[0,1]^{2×m}, R^{w} ∈[0, 1]^{2×2}, S^{w} ∈[0,1]^{2×m} are defined as shown in FIG. 2C. If Pa_v (X)∩Pa_v (A)≠∅ and Pa_v (X)=z and Pa_v (A)=w conflict, then Q_{0,i}^{w}=Q_{1,i}^{w} are set equal to zero.

Then, the following are calculated: Q^{W}=R^{w} S^{w} and S^{w}=(R^{w})⁻¹Q^{w}. Letting S be the marginalization over w: Σ_{w}S^{w}=(R^{w})⁻¹Q^{w}, then S_{w,i}= [symbol] (X=1, Pa_v (X)=zᵢ, V=v) is calculated.

The factor for each X, a remaining behavior that does not have V as a parent, is then determined to be equal to

[symbol]

(X|Pa_v(X)=zᵢ,V=v)=S_{v,i}/ [symbol] (Pa_v(X)=zᵢ,V=v).

The factors for nodes with V as a parent are fit in topological order, so the denominator in the above equation can always be calculated from previously fit factors.

A system using a latent variable model as described above can determine accurate estimates of the real preferences of users by looking at their behavioral data, thus providing a basis for offering better recommendations.

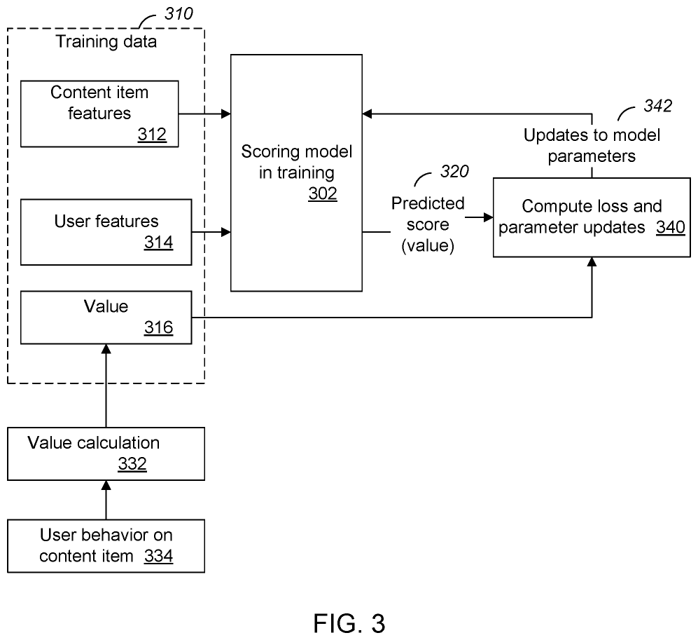

FIG. 3 illustrates an example flow of data and processing for training a scoring model 302 to generate scores corresponding to value.

The scoring model 302, when being trained, receives training data 310. This includes many instances of a feature vector representing a content item 312, a feature vector representing a user 314, and a label 316, which is the value determined for the content item and user as described above.

The scoring model generates a prediction of the value, i.e., the score, 320. The training process computes (340) a loss value of a loss function from the difference between the prediction 320 and the label 316, and from the loss value, it calculates (340) parameter updates 342 for the parameters of the scoring model.

The scoring model can be any kind of machine learning model suitable for performing regression calculations. The use of a deep neural network model can be advantageous. The loss function can be a conventional L₁ or L₂ norm based loss function.

The value 316 for a particular instance of content item and user is determined, using the value calculation method 332 described above in reference to FIGS. 2A-2C, from the behavior 334 of the user on the content item.

The feature vector for each content item may include, for example, representations of one or more of the following features relating to the content: its length; its age; representations of terms or phrases in the content; a measure of the sentiment of the content, positive or negative; a measure of the virality of the content; a measure of whether a topic of the content is trending, i.e., has become recently popular; whether or not the item includes images, video, or links; any key phrases, e.g., hashtags; references to specific users; whether item is an advertisement; or which topics the item relates to, among others.

The feature vector for each content item may also include, for example, representations of one or more of the following features relating to the author of the content item, to the extent permitted by the author's privacy settings: interests; the author's areas of expertise; a measure of how connected the author is to the user; the number of followers, i.e., follower accounts; the number of followed accounts; country; the author's preferred language or languages; the author's gender; the author's age; or the current rate at which the author posts new content items, replies to content items, or forwards content items.

The feature vector for each content item may also include, for example, representations of one or more of the following features relating to the user for whom content items are being ranked or recommended, to the extent permitted by the author's privacy settings: information in the user's profile, e.g., interests, areas of expertise, languages used, or accounts the user is following or is followed by, or other data, e.g., data representing the user's history on the system providing the content.

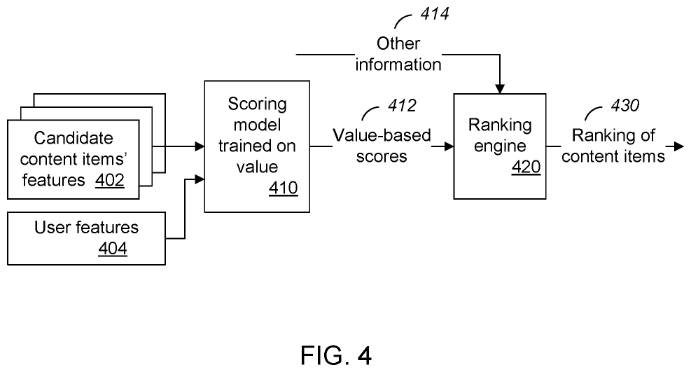

FIG. 4 illustrates an example flow of data and processing in which a scoring model 410 is used in connection with a ranking engine 420. The ranking engine can be used directly as a recommender system to recommend content items to a user, or its output can be provided to a further system that selects ranked content items for recommendation. The content items can be presented to the user as such, or links to the content items can be provided. The input content items and the output ranking can be used to define a stream of content for a user separate from other streams, e.g., a stream of content specifically requested by the user, which may be ordered chronologically or on the basis of some objective other than value, or the contents of such other stream can be supplemented by the addition of a few highly-ranked content items as suggestions identified by the ranking engine.

The scoring and ranking are done over a set of candidate content items. The candidate content items can be selected by applying a coarse filter to a universe of available content items, e.g., by filtering for items that are sufficiently recent and in a language used by a user. In some scenarios, the candidate content items may be content items that satisfy a search query received from a user.

The trained scoring model receives respective features 402 for candidate content items and features 404 for a user. Generally, each of the content items and the user are represented by a respective vector of features. The model is executed to produce a value-based score 412 for each of the candidate content items. The ranking engine 420 receives the scores and possibly other information 414, and generates a ranking 430 of the content items or ranking scores for the content items. If no other information 414 is considered, the ranking is according to the value-based scores. The other information may include, by way of example, one or more of the following: a measure of similarity between candidate content items and between candidate content items and content items recently view by the user; or a measure of cost to deliver the content item to the user's device in view of available bandwidth and a cost to the user of delivering data to the user. The ranking engine, with other information, can rank content items based on a weighted ranking score computed from the value-based scores and scores derived from the items of other information. A weighted ranking score can, for example, increase a likelihood that divers, as yet unseen, and less costly content items will be more highly ranked.

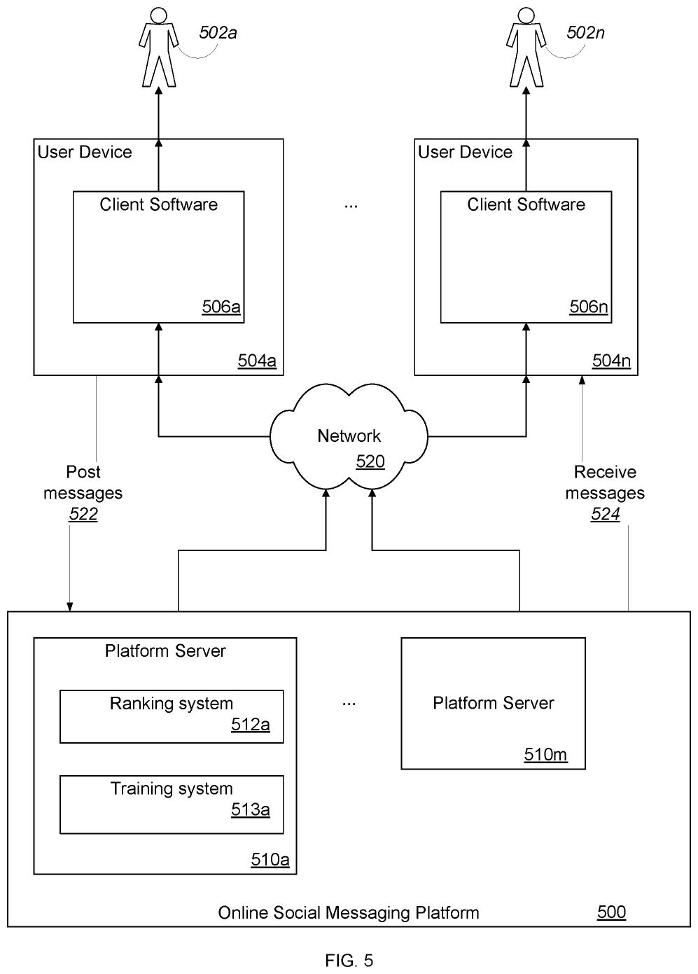

FIG. 5 illustrates an example online social messaging platform 500 and example user devices 504a-504n configured to interact with the platform over one or more data communication networks 520. The platform is one context in which the technologies described in this specification can be implemented.

The platform is implemented on one or more servers 510a-510m. Each server is implemented on one or more computers, e.g., on a cluster of computers, in one or more locations. One or more of the servers can implement elements 512a of the ranking technology that calculates a ranking of content based on estimates of value as described in reference to FIGS. 1, 2, and 4, above. The same or different servers can implement the elements 513a of the training system described in reference to FIG. 3, above.

Users 502a-502n of the platform can use their user devices 504a-504n, on which client software 506a-506n is installed, to interact with the platform, e.g., to post 522 and receive 524 messages, view and curate the user's streams, and view and interact with lists of content items that are ranked or recommended by the platform, e.g., by a model trained in accordance with the technologies described above.

A user may be account holder of an account, or an authorized user of an account, on the platform. The platform may have millions of accounts of individuals, businesses, or other entities, e.g., pseudonym accounts, novelty accounts, and so on.

The platform is configured to provide content items, generally messages, to a user in a home feed message stream. The platform can generate content recommendations for the home feed message stream using expected value probabilities calculated as described above. The platform is configured to include in a recipient user's home feed stream messages that the platform determines are likely to have value for the recipient.

When content items are provided to a user by the platform, the items may include annotations identifying various properties associated with the items or their authors. The annotations may include, for example, annotations identifying a topic or topic to which the item relates, annotations indicating the author is an expert in a topic to which the item relates, or an icon indicating that the platform has identified the item has having a high predicted value to the user.

A message generally contains data representing content provided by the author of the message. The types of data that may have been stored in a message include text, graphics, images, video, and computer code, e.g., uniform resource locators (URLs). Messages can also include key phrases, e.g., hashtags, that can aid people or the platform in categorizing messages or relating messages to topics. Messages can also include metadata that may or may not be editable by the author, depending on the implementation of the platform. Examples of message metadata include a time and date of authorship and a geographical location of the user device when it submitted the message. In some implementations, what metadata is provided to the platform by a client is determined by privacy settings controlled by the user or the account holder.

Messages composed by one account holder may reference other accounts, other messages, or both. A message may be composed in reply to another message. A message may also be a republication of a message received from another account. Generally, an account referenced in a message may appear as visible content in the message and may also appear as metadata in the message.

In this example platform, messages are microblog posts, which differ from e-mail messages, among other ways, in that an author of a microblog post does not necessarily need to specify, or even know, who the recipients of the message will be.

A stream is a stream of content items on the platform that meet one or more stream criteria. A stream can be defined by the stream criteria to include messages posted by one or more accounts. For example, the contents of a stream for a requesting account holder may include one or more of (i) messages composed by that account holder, (ii) messages composed by the other accounts that the requested account holder follows, (iii) messages authored by other accounts that reference the requested account holder, or (iv) messages sponsored by third parties for inclusion in the account holder's message stream. The messages of a stream may be ordered, at the user's discretion, chronologically by time and date of authorship, or reverse chronologically, or by a computed ranking, e.g., the value-based ranking described above. Streams may also be ordered in other ways, e.g., according to some combination of time and value score. A separate value-based stream of recommend content items may also be provided.

A stream may potentially include a large number of messages. For both processing efficiency and the requesting account holder's viewing convenience, the platform generally identifies a subset of messages meeting the stream criteria to send to a requesting client once the stream is generated. The remainder of the messages in the stream are maintained in a stream repository and can be accessed upon client request.

Generally, the platform does not require an account holder to provide a large amount of personal information. This personal information can include, for example, an account name, which is not necessarily a real name, an identifier, a user name, a picture, a brief description of the account holder, an e-mail address, and a website. The personal information does not necessarily include, and may specifically exclude, real-world identifying information like age, gender, interests, history, occupation, and so on. Information about each account is stored in an account repository of the platform.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

A computer program can be written in any form of programming language, including compiled or interpreted languages, or declarative or procedural languages; and it can be deployed on a system of one or more computers in any form, including as a stand-alone program, e.g., as an app, or as a module, component, engine, subroutine, or other unit suitable for executing in a computing environment, which environment may include one or more computers interconnected by a data communication network in one or more locations.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on one or more computers having, or configured to communicate with, a display device, e.g., a LCD (liquid crystal display) or organic light-emitting diode (OLED) monitor, a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a method comprising:
providing value-based training data, the training data comprising multiple instances of (i) user features, (ii) features of corresponding content items presented to users, and (iii) respective values determined for each of the content items for the users, the respective values being determined, from user behaviors with respect to content items presented to the users, by a value model based on an anchor variable in the user behaviors;
training a scoring model on the training data to generate value-based scores from user features and content item features;
ranking a plurality of candidate content items selected for a first user by a ranking engine, wherein the ranking engine receives respective value-based scores generated by the trained scoring model for the candidate content items and the first user; and
providing two or more of the candidate content items for presentation to the first user in an order determined by the ranking.

Embodiment 2 is the method of embodiment 1 wherein providing value-based training data comprises:
providing historical data representing content items and data representing, for each presentation of each content item, acts of user behavior made in response to each presentation of each content item; and
evaluating the historical data with a latent variable model that has value to a respective user as an unobserved latent variable, that has user actions as variables, and that has a particular user action as an anchor variable, to generate training data representing a measure of value of each content item to the user who responded to the content item with one or more user actions.

Embodiment 3 is the method of any one of embodiments 1-2 wherein the particular user action of the anchor variable is a show less often action.

Embodiment 4 is the method of any one of embodiments 1-3 wherein the latent variable model is represented as a Bayesian network that encodes user actions and the latent variable as nodes in a directed acyclic graph that encodes all conditional independences among the nodes through the d-separation rule.

Embodiment 5 is the method of any one of embodiments 1-4 wherein providing candidate content items for presentation comprises providing the candidate content items as such or providing links that a user can select to obtain the candidate content items.

Embodiment 5 is the method of any one of embodiments 1-5 wherein providing candidate content items for presentation comprises providing recommendations of the candidate content items for presentation to the first user.

Embodiment 7 is the method of any one of embodiments 1-6 wherein providing candidate content items for presentation comprises providing, with content items that have value-based scores above a predetermined threshold, a mark indicating a high predicted value for the first user.

Embodiment 8 is the method of any one of embodiments 1-7, further comprising: generating the candidate content items by performing a search of content items in response to a query received from the first user.

Embodiment 9 is a system comprising one or more computers and one or more storage devices on which are stored instructions that are operable, when executed by the one or more computers, to cause the one or more computers to perform operations comprising the operations of any one of embodiments 1 to 8.

Embodiment 10 is a computer program carrier encoded with computer program instructions that when executed by one or more computers cause the one or more computers to perform operations comprising the operations of any one of embodiments 1 to 8.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method, comprising:
providing value-based training data, the training data comprising multiple instances of (i) user features, (ii) features of corresponding content items presented to users, and (iii) respective values of a value variable determined for each of the content items for the users, the respective values being determined, from user behaviors with respect to content items presented to the users, by a value model based on an anchor variable in the user behaviors;
training a scoring model on the training data to generate value-based scores from user features and content item features;
ranking a plurality of candidate content items selected for a first user by a ranking engine, wherein the ranking engine receives respective value-based scores generated by the trained scoring model for the candidate content items and the first user; and
providing two or more of the candidate content items for presentation to the first user in an order determined by the ranking.

2. The method of claim 1, wherein providing value-based training data comprises:
providing historical data representing content items and data representing, for each presentation of each content item, acts of user behavior made in response to each presentation of each content item; and
evaluating the historical data with a latent variable model that has value to a respective user as an unobserved latent variable, that has user actions as variables, and that has a particular user action as an anchor variable, to generate training data representing a measure of value of each content item to the user who responded to the content item with one or more user actions.

3. The method of claim 2, wherein the particular user action of the anchor variable is a show less often action.

4. The method of claim 2, wherein the latent variable model is represented as a Bayesian network that encodes user actions and the latent variable as nodes in a directed acyclic graph that encodes all conditional independences among the nodes through the d-separation rule.

5. The method of claim 1, wherein providing candidate content items for presentation comprises providing the candidate content items as such or providing links that a user can select to obtain the candidate content items.

6. The method of claim 1, wherein providing candidate content items for presentation comprises providing recommendations of the candidate content items for presentation to the first user.

7. The method of claim 1, wherein providing candidate content items for presentation comprises providing, with content items that have value-based scores above a predetermined threshold, a mark indicating a high predicted value for the first user.

8. The method of claim 1, comprising:
generating the candidate content items by performing a search of content items in response to a query received from the first user.

9. A system comprising:
one or more computers and one or more storage devices on which are stored instructions that are operable, when executed by the one or more computers, to cause the one or more computers to perform operations comprising:
providing value-based training data, the training data comprising multiple instances of (i) user features, (ii) features of corresponding content items presented to users, and (iii) respective values of a value variable determined for each of the content items for the users, the respective values being determined, from user behaviors with respect to content items presented to the users, by a value model based on an anchor variable in the user behaviors;
training a scoring model on the training data to generate value-based scores from user features and content item features;
ranking a plurality of candidate content items selected for a first user by a ranking engine, wherein the ranking engine receives respective value-based scores generated by the trained scoring model for the candidate content items and the first user; and
providing two or more of the candidate content items for presentation to the first user in an order determined by the ranking.

10. The system of claim 9, wherein providing value-based training data comprises:
providing historical data representing content items and data representing, for each presentation of each content item, acts of user behavior made in response to each presentation of each content item; and
evaluating the historical data with a latent variable model that has value to a respective user as an unobserved latent variable, that has user actions as variables, and that has a particular user action as an anchor variable, to generate training data representing a measure of value of each content item to the user who responded to the content item with one or more user actions.

11. The system of claim 10, wherein the particular user action of the anchor variable is a show less often action.

12. The system of claim 10, wherein the latent variable model is represented as a Bayesian network that encodes user actions and the latent variable as nodes in a directed acyclic graph that encodes all conditional independences among the nodes through the d-separation rule.

13. The system of claim 9, wherein providing candidate content items for presentation comprises providing the candidate content items as such or providing links that a user can select to obtain the candidate content items.

14. The system of claim 9, wherein providing candidate content items for presentation comprises providing recommendations of the candidate content items for presentation to the first user.

15. The system of claim 9, wherein providing candidate content items for presentation comprises providing, with content items that have value-based scores above a predetermined threshold, a mark indicating a high predicted value for the first user.

16. The system of claim 9, wherein the operations comprise:
generating the candidate content items by performing a search of content items in response to a query received from the first user.

17. One or more non-transitory computer storage media encoded with computer program instructions that when executed by one or more computers cause the one or more computers to perform operations comprising the operations comprising:
providing value-based training data, the training data comprising multiple instances of (i) user features, (ii) features of corresponding content items presented to users, and (iii) respective values of a value variable determined for each of the content items for the users, the respective values being determined, from user behaviors with respect to content items presented to the users, by a value model based on an anchor variable in the user behaviors;
training a scoring model on the training data to generate value-based scores from user features and content item features;
ranking a plurality of candidate content items selected for a first user by a ranking engine, wherein the ranking engine receives respective value-based scores generated by the trained scoring model for the candidate content items and the first user; and
providing two or more of the candidate content items for presentation to the first user in an order determined by the ranking.

18. The computer storage media of claim 17, wherein providing value-based training data comprises:
providing historical data representing content items and data representing, for each presentation of each content item, acts of user behavior made in response to each presentation of each content item; and
evaluating the historical data with a latent variable model that has value to a respective user as an unobserved latent variable, that has user actions as variables, and that has a particular user action as an anchor variable, to generate training data representing a measure of value of each content item to the user who responded to the content item with one or more user actions.

19. The computer storage media of claim 18, wherein the particular user action of the anchor variable is a show less often action.

20. The computer storage media of claim 18, wherein the latent variable model is represented as a Bayesian network that encodes user actions and the latent variable as nodes in a directed acyclic graph that encodes all conditional independences among the nodes through the d-separation rule.

21. The computer storage media of claim 17, wherein providing candidate content items for presentation comprises providing the candidate content items as such or providing links that a user can select to obtain the candidate content items.

22. The computer storage media of claim 17, wherein providing candidate content items for presentation comprises providing recommendations of the candidate content items for presentation to the first user.

23. The computer storage media of claim 17, wherein providing candidate content items for presentation comprises providing, with content items that have value-based scores above a predetermined threshold, a mark indicating a high predicted value for the first user.

24. The computer storage media of claim 17, wherein the operations comprise:
generating the candidate content items by performing a search of content items in response to a query received from the first user.
